(19) United States
(12) Patent Application Publication
(10) Pub. No.: US 2020/0332913 A1
(43) Pub. Date: Oct. 22, 2020

(54) VALVE DEVICE

(71) Applicant: HYDAC ACCESSORIES GMBH, Sulzbach/Saar (DE)

(72) Inventors: Jörg STEFFENSKY, Dillingen (DE); Martin SCHMITT, Knopp-Labach (DE); Stefan Christian SAUER, Schwalbach/Elm (DE); Torsten BLEY, Beckingen (DE)

(21) Appl. No.: 16/648,310

(22) PCT Filed: Sep. 17, 2018
(86) PCT No.: PCT/EP2018/075096

§ 371 Date: Jun. 12, 2020

(30) Foreign Application Priority Data
Sep. 23, 2017 (DE) 10 2017 008 943.4

(51) Int. Cl. F16K 31/06; F16K 1/12

(52) U.S. Cl. CPC F16K 31/0651; F16K 1/123; F16K 31/0655

(57) ABSTRACT

A valve device having a valve housing (4), in which a hollow valve part (6) is guided in a longitudinally movable manner, which valve part, controlled by an actuating device (8,14), in at least one open position opens the fluid path through the valve between a fluid inlet (E) and a fluid outlet (A) along a predeterminable flow path for a fluid and in a closed position, in which the valve part (6) is in contact with a valve closing part (10) from which it lifts off in the respective open position, blocks this fluid path, is characterized in that there is at least one flow guide device causing an at least partial reversal of direction in the flow path of the fluid emerging from the valve part (6) as soon as the latter assumes an open position.

The invention relates to a valve device having a valve housing in which a hollow valve part is guided in a longitudinally movable manner, which, controlled by an actuating device, in at least one open position opens the fluid path through the valve between a fluid inlet and a fluid outlet along a predeterminable flow path for a fluid and in a closed position, in which the valve part is in contact with a valve closing part from which it lifts off in the open position, blocks this fluid path.

A generic coaxial valve, having a valve housing, in which a hollow valve part in the form of a tube is guided in a longitudinally movable manner, which valve part interacts with a valve seat at the end face, which is arranged in a valve closing part, is known from DE 101 21 616 A1. In addition, a magnetic drive is provided as an actuating device for moving the hollow valve part, which magnetic drive has an armature attached to the outside of the valve part, wherein chambers on both sides of the armature in the direction of motion are connected to one another via a passage having a defined cross-section. The cross-section of the passage is selected such that the closing motion of the valve part towards the valve closing part having the valve seat is slowed down. The opening and closing characteristics of the valve can thus be adjusted by selecting the cross-section of the passage accordingly. In particular, when closing the known valve, which is effected by the force of an energy storage device in the form of a compression spring or by the magnetic drive itself, the hollow valve part can be prevented from hitting the valve seat of the valve closing part too hard, which is also known in technical terms as “closing impact”. Preventing closing impacts prolongs the service life of the valve. The slower closing behavior, however, prevents a rapid response of the valve, such that the known valve is not suitable for a large number of applications where a rapid response of the valve part is required.

It has also been shown in practice that pressure fluctuations at the valve input or output end can cause an undesired opening process in such coaxial valves when the hollow valve part is simply pushed away from the valve closing part having the valve seat against the spring force of the compression spring.

To counteract this, DE10 2005 012 851 A1 has proposed to mount the valve seat for a coaxial valve such that it can be moved in the axial direction of motion of the hollow valve part and in doing so have the pressurized medium in the hollow valve part apply this pressure to the valve seat in the direction of the hollow valve part; however, a connecting channel must be provided for this solution, which connecting channel connects the valve cavity to the rear end of the valve seat, to ensure in this way that the valve seat of the valve closing part is always pressurized in the direction of the hollow valve part. However, to reliably prevent any clogging and contamination of this connecting channel due to impurities in the fluid to be controlled, additional equipment is required, such as a membrane closing part that can be controlled for temporarily closing the connecting channel or a filter that is inserted in the channel.

Based on this state of the art, the invention therefore addresses the problem of creating, in a cost-effective and functionally reliable manner, a valve device which prevents the hollow valve part from hitting the valve closing part too hard and yet makes for a rapid response and ensures that there is no undesired opening of the valve device due to pressure fluctuations during operation.

A valve device having the features of claim 1 solves this problem.

Because according to the characterizing part of patent claim 1, there is at least one flow guide device causing an at least partial reversal of direction in the flow path of the fluid emerging from the valve part as soon as the latter assumes an open position, ensures that the distance between the valve part and the valve closing part, which decreases during the closing of the hollow valve part when the valve device is closed, simultaneously results in a decrease of harmful flow velocities and pressure losses, effectively preventing pressure surges or closing impacts. In particular, due to the reversal of direction, there are no longer any flow-related suction effects, which may otherwise result in cavitation and in the closing impacts mentioned. In this way, the service life of such valve devices can be significantly increased without impairing their response behavior. In particular, the valve according to the invention can be switched quickly if necessary.

Furthermore, it is surprising for an average expert in the field of coaxial valves that the reversal of direction of the flow path by means of the flow guide device according to the invention, prevents any undesired opening of the valve device, even in the case of pressure fluctuations on the fluid inlet end or fluid outlet end of the valve device, because the hollow valve part remains safely on the valve closing part in the closed position.

In a preferred embodiment of the valve device according to the invention, provision is made that at least one further flow guide device adjoins the one flow guide device in the direction of the flow path of the fluid in sequence, which further flow guide device complements the direction reversal in the flow path effected by the one flow guide device by one at least partial further direction reversal in such a way that preferably after passing through the two direction reversals of the fluid, the rectilinear fluid flow direction predominantly present in the valve part is restored after passing through both flow guide devices. In this way, a significantly longer flow path through the two guide devices is achieved when the valve device is open compared to the known solutions, which results in a reduction of the flow velocity for the flow of a predeterminable amount of fluid over time, which adds to the desired active damping in the closing position.

In a further preferred embodiment of the valve device according to the invention, it is provided that the one flow guide device is formed by parts of the valve part and of the valve closing part, which delimit the flow path of the fluid exiting from the valve part in its open position in the context of the reversal of direction.

Preferably provision is further made that the further flow guide device is formed from parts of the one flow guide device and from a guiding device, which is preferably formed from wall parts of the valve housing.

In this way, the individual flow line including flow reversal can be implemented using valve components existing in the valve design, which contributes to reducing costs and increases the functional reliability due to the small number of existing components.

In a particularly preferred embodiment of the valve device according to the invention, it is provided that the two flow guide devices, forming an overall flow guide device, are co-planar, which at least one plane extends through the longitudinal axis of the valve part and in which the flow path of the fluid is wave-shaped. The preferably sinusoidally extending wave forms an annular wave band across the entire cross-section of the valve device according to the invention, which implies an undisturbed flow, obviating energy losses during operation.

It is particularly preferred that the two flow guide devices are at least partially formed by wall parts of the valve part, the valve closing part and the guiding device, which in concentric arrangement to each other delimit annular flow chambers between the valve part and the valve closing part and between this closing part and the guiding device. The discrete flow chambers formed in this way permit the undisturbed build-up of the waveform during the flow operation of the valve device.

The fact that the valve closing part, in contrast to known solutions (DE10 2005 012 851 A1), is arranged stationarily in the valve housing and has a closing plate of preferably elastomeric material, against which the valve part is brought into sealing contact in its closed position upon the action of an energy storage device as one part of the actuating device for a not energized actuating magnet as a further part of the actuating device, results in a structurally simple design having few movable valve components, which contributes to functional safety.

Maintenance is also simplified, and the closing plate on the valve closing part can be easily replaced with a new part if necessary, for instance if it is worn. Because the closing plate, which is preferably made of an elastomer material, can be incompatible with certain media, a closing plate can easily be replaced by a more robust one, depending on the fluid or media used.

Because in a preferred embodiment of the valve device according to the invention, in the fully open position of the valve part, a magnet armature of the actuating magnet has moved until it is full contact against a pole core of the actuating device, leaving a separating gap as a magnetic separation, and in that way the valve part is disengaged from the valve closing part in its axial direction of travel and the end faces of the valve part and the valve closing part facing each other are axially spaced apart from each other, the choice of the distance between the valve part and the valve closing part also permits adjusting the magnetic separation according to requirements via the size of the air gap.

In another preferred embodiment of the valve device according to the invention, provision is made that in the closed position of the valve part its free end face in the manner of a control edge is enclosed by an annular control edge of another type of valve closing part, forming the one flow chamber. The two control edges can not only be optimally adjusted in relation to each other and can be easily manufactured with regard to their respective frontal access, which includes height, depth and angle adjustment, but can also be manufactured simply and inexpensively.

Furthermore, it is advantageous for the operation of the valve device that when valve part is increasingly opened, its free end face moves away from the closing plate of the valve closing part in the axial direction, enlarging the one flow chamber, and that in the fully open position of the valve part, the one free end face is flush with the guiding device, which co-delimits the further flow chamber. During operation of the valve device, the respective fluid fillings of the two flow chambers stabilize the travel motions from the valve part to the valve closing part preventing instabilities from occurring during operation.

The wave-shaped flow pattern mentioned above is further promoted and stabilized by the annular control edges also being co-delimited by a conically inclined annular surface on the valve part and/or on the valve closing part at their respective free ends and that the annular surface of the valve closing part is inclined in the direction of the fluid outlet and that the other annular surface of the valve part is inclined in the direction of the fluid inlet.

In a further preferred embodiment of the valve device according to the invention, the valve closing part is accommodated in the valve housing between housing parts thereof, preferably in a clamping manner, which also co-delimit a kind of torus which is co-formed by the further flow chamber, which preferably adjoins the other torus chamber in a continuously widening manner. By designing a flow chamber in the manner of a torus, the fluid passages in the transition area from valve part to valve closing part and the fluid outlet of the device are homogenized resulting in cavitation-forming turbulences being eliminated due to the laminar flow achieved in this way. Advantageously the valve closing part passes through the torus and has passages arranged on an annular flange, both ends of which open into the torus, which, on the outlet end, is routed in the direction of the fluid outlet of the valve device. Because a large number of identical parts can be used in the valve device according to the invention, also using different sealing materials, manufacturing costs are accordingly reduced compared to known solutions. Another factor in aid thereof is the valve closing part being basically designed as a turned part which can be assembled from only four components, to wit a seal for a sealing insert, which can be secured in a seat receptacle of the valve closing part by means of a fastener, such as a single set screw. The seal is formed by the elastomeric closing plate and the sealing insert itself is an independent component, which guides the control edge of the valve closing part.

The invention is explained in detail with reference to the drawings below.

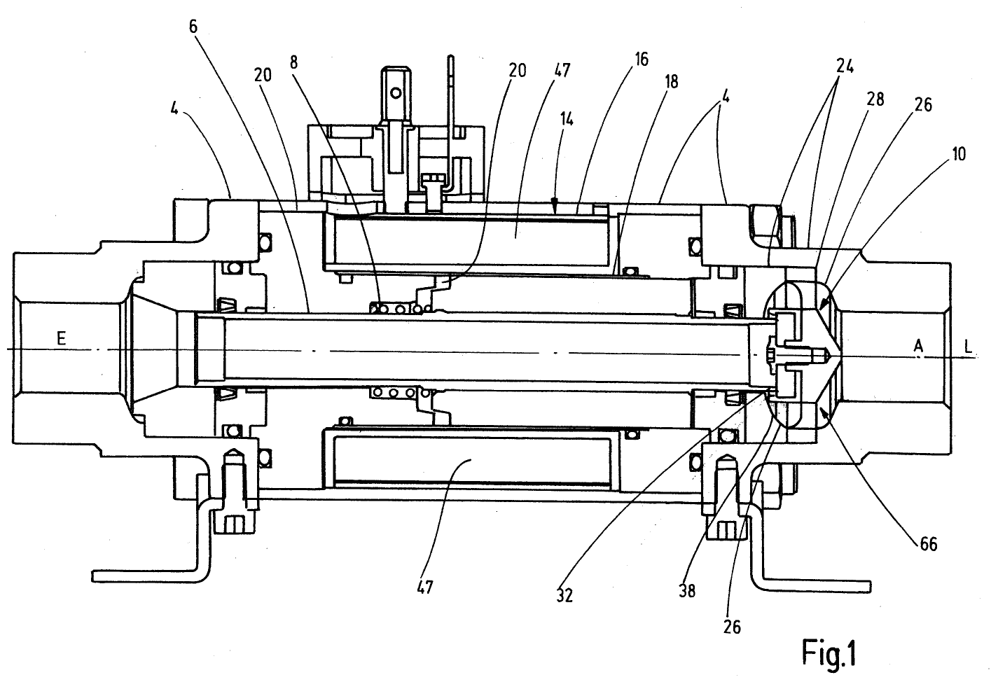

FIG. 1 shows a schematically simplified longitudinal section of the valve device having a valve part arranged in its closed position;

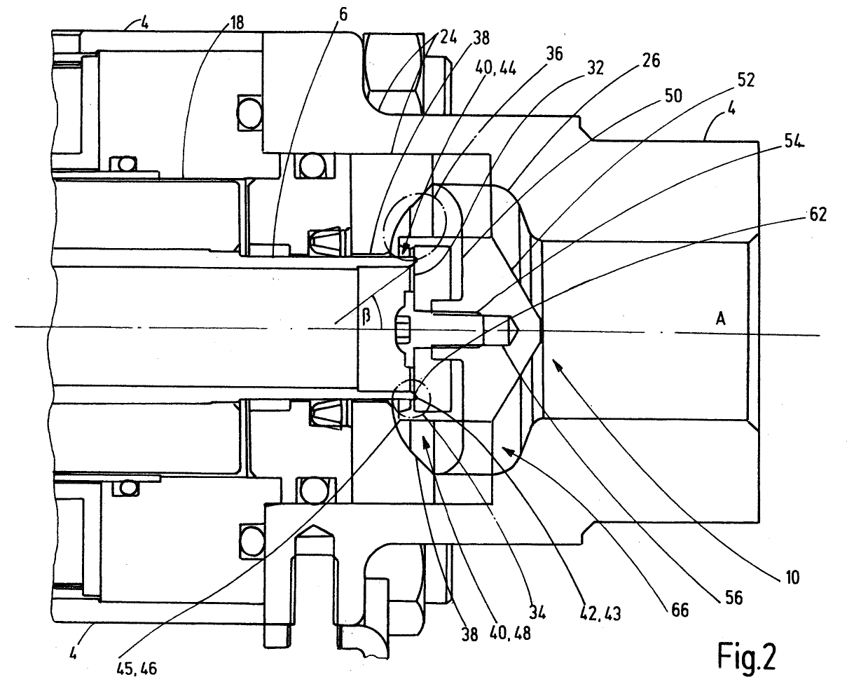

FIG. 2 shows a schematically simplified longitudinal section of a free end area of the valve device as shown in FIG. 1, enlarged and broken off compared to FIG. 1;

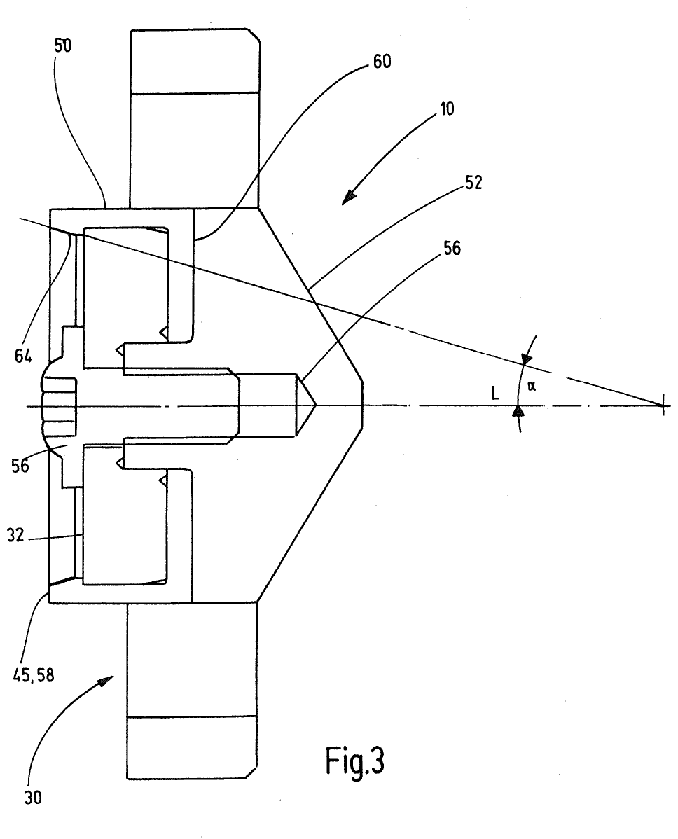

FIG. 3 shows a schematically simplified longitudinal section of a valve closing part of the valve device as shown in Figs.1 and 2; and

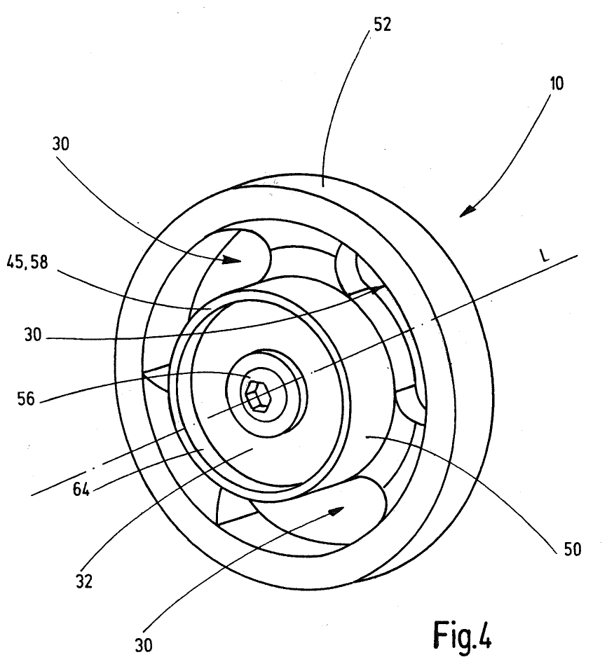

FIG. 4 shows a perspective oblique view of a valve closing part of the valve device shown in FIG. 3.

FIG. 1 shows a schematically simplified longitudinal section of the valve device, which has a valve housing 4, in which a hollow, cylindrical valve part 6 is guided in a longitudinally movable manner. FIG. 1 shows the valve part 6 under the action of an energy storage device 8 in the form of a compression spring as part of an actuator 8,14 in a closed position in contact with a closing part 10, in which closed position it blocks the fluid path through the valve device between a fluid inlet E and a fluid outlet A along a predeterminable flow path for a fluid, such as a hydraulic fluid (oil).

In at least one open position not shown in more detail in the figures, in which the valve part 6, controlled by a magnetic force actuatorl4 as a further part of the actuator 8,14, disengages from the valve closing part 6 in its axial direction of travel against the action of the compression spring 8 and lifts off from the latter, the fluid path through the valve device between the fluid inlet E and the fluid outlet A along the predeterminable flow path is opened for the fluid. In this open position of valve part 6, the end faces 42, 46 of the valve part 6 and the valve closing part 10 facing each other are axially spaced apart.

The magnetic force actuatorl4 shown in FIG. 1 comprises an energizable actuating magnet 16, which has a coil winding 47 in the usual manner and is therefore not further described in detail, which coil winding can be energized externally via a connector part. Furthermore, a longitudinally movable magnet armature 18 is provided, which acts directly on the valve part 6 in direct contact and is firmly connected thereto. When the coil winding 47 is energized, the magnet armature 18 travels—viewed towards FIG. 1—to the left from its de-energized state of the coil winding 47 shown in FIG. 1 and moves the valve part 6 to the left in the same way, against the action of the energy storage device 8 in the form of a compression spring. In the fully open position of the valve part 6, the magnet armature18 of the actuating magnet 16 has been moved until it is in full contact against a pole core 22 of the actuating device14, 8, leaving a separating gap 20 open, which is used as a graduated magnetic separation for the actuating magnet 16.

As shown in FIG. 2, the valve closing part 10 is accommodated in the valve housing 4 between housing parts 24 of the latter, preferably in a clamping manner, and is arranged there in a stationary manner. The housing parts 24 delimit a kind of torus 26 within the valve housing 4, through which the valve closing part 10 extends and which is routed in the direction of the fluid outlet A on the outlet end. As shown in FIG. 4, the valve closing part 10 has passages 30 arranged on an annular flange 28, both ends of which open into the torus 26 and preferably follow a circular path, and has a closing plate 32 shown in FIG. 3, preferably made of elastomeric material, against which the valve part 6 is brought into sealing contact in its closed position upon the action of the energy storage device 8 when the actuating magnet 16 is not energized.

As further illustrated in FIG. 2, the valve device comprises a flow guide device 34 which causes a 180° reversal of direction in the flow path of the fluid exiting from the valve part 6 when the latter assumes an open position, which is not further illustrated in the figures. One flow guide device 34 is essentially formed by parts of the valve part 6 and the valve closing part 10, which delimit the flow path of the fluid exiting from the valve part 6 in its open position, in the context of the reversal of direction.

In the direction of the flow path of the fluid, at least one further flow guide device 36 shown in FIG. 2 adjoins the one flow guide device 34, which adds to the reversal of direction in the flow path effected by the one flow guide device 34 by at least partially a further reversal of direction by again 180° in such a way that the rectilinear fluid flow direction predominantly present in the valve part 6 is maintained again in the direction of the fluid outlet A after passing through the two flow guide devices 34, 36 after the fluid has passed through the two reversals of direction. The further flow guide device 36 is formed by parts of the one flow guide device 34 and by a guiding device 38 made of wall parts of the valve housing 4, which also co-delimit the torus 26.

The one flow guide device 34 and the further flow guide device 36, forming an overall flow guide device, are co-planar in least one common fictitious plane lying in the figure plane, which in each case runs through the longitudinal axis L of the valve part 6 and in which the flow path of the fluid is wave-shaped. The two flow guide devices 34, 36 are at least partially formed from wall parts of the valve part 6, the valve closing part 10 and the guiding device 38, which in a concentric arrangement to each other delimit annular flow chambers 40 between the valve part 6 and the valve closing part 10 and between this valve closing part 10 and the guiding device 38. To this extent, the fictitious planes and the waveform also form closed, annular three-dimensional chambers.

As FIG. 2 shows, in the closed position of the valve part 6, its free end face 42 in the manner of an annular control edge 43 is enclosed by an annular control edge 45 of a different type of valve closing part 10, which annular control edge is formed on its free end face 46, forming a flow chamber 44. As FIG. 3 shows, the annular control edge 45 on the valve closing part 10 is co-delimited by a conical annular surface 64 inclined in the direction of the fluid outlet A at the free end thereof. As FIG. 2 shows, the annular control edge 43 of the valve part 6 is co-delimited by the free end of another conical annular surface 62 on the valve part 6, which conical annular surface is inclined towards the fluid inlet E. As not shown in more detail in the figures, when the valve part 6 is increasingly opened, its free end face 42 moves away from the closing plate 32 of the valve closing part 10 in the axial direction, enlarging the one flow chamber 44. In the fully open position of the valve part 6, its one free end face 42 is flush with the guiding device 38, which also co-delimits a further flow chamber 48. The torus 26 also forms the further flow chamber 48, which preferably adjoins the other torus chamber 66 in a continuously expanding manner.

As FIG. 3 shows, the valve closing part 10 also has a cylindrical sealing insert 50, designed as a rotating part, having a bottom 60 at the end, through which a lead-through extends, and a seal mount 52. The closing plate 32 is received in the sealing insert 50. At its smallest point, the inner diameter of the sealing insert 50 is larger than the outer diameter of the valve part 6. The seal mount 52 has a blind hole 54 provided with a female thread for bolting a set screw 56, by means of which the locking plate 32 and the seal insert 50 can be immobilized on the seal mount 52, in particular by the bolt head acting on the locking plate 32 and extending through passages in the locking plate 32 and the seal insert 50. The edge area of the sealing insert 50 facing the fluid inlet E, which protrudes beyond the closing plate 32 towards the valve part 6, forms the annular control edge 45 of the valve closing part 10.

The inner wall facing the inside of the sealing insert 50 and also co-delimiting the control edge 45 of the valve closing part 10, extends, viewed in a longitudinal section as shown in FIG. 3, from one end 58 of the sealing insert 50 in the direction of the other end 60 at the bottom end, initially inclined towards the longitudinal axis L of the valve closing part 10, in particular tapers off conically at an angle α of 8 to 18 degrees, preferably 13 degrees. A course without inclination parallel to the longitudinal axis L of the valve closing part 10, at which the sealing insert 50 has its smallest internal diameter adjoins the inclined course towards the other end 60. The ratio between the inclined course and the inclination-free course ranges from 10:1 to 10:5, preferably 10:3. After the course of the control edge 45 without any inclination, the inner diameter of the inner wall of the sealing insert 50 expands abruptly. In the area of this inner diameter expansion, the closing plate 32 is arranged such that the end of the control edge 45 of the sealing insert 50 facing the closing plate 32 protrudes beyond the closing plate 32 in the direction of the longitudinal axis L of the valve closing part 10 in the manner of a projection.

The inner wall facing the inner end of the valve part 6 and also co-delimiting the control edge 43 of the valve part 6 extends, in a longitudinal section as shown in FIG. 2, from the end face 42 of the valve part 6 in the direction of its other end face inclined towards the longitudinal axis L of the valve part 6, in particular tapers, at an angle β in a range from 30 to 40 degrees, preferably of 35 degrees.

To guide the fluid flow, the seal mount 52 is partially tapered on its end facing away from the seal insert 50 and on its end facing the fluid outlet A.

The flow path of a fluid flowing through the valve from the fluid inlet E to the fluid outlet A is described below:

When the valve closing part 10 is in one of its open positions, which is not shown in more detail in the figures, in a first step the fluid flows starting from the fluid inlet E through the hollow valve part 6 in a substantially straight line. In a second step, the fluid flows through one of the flow guide devices 34, which causes a 180° reversal of direction of the flow path, and directly thereafter in a third step, the fluid flows through the other flow guide device 36, which causes a further 180° reversal of direction of the flow path. In this process, the fluid passes through the one flow chamber 44 and therethrough reaches the further flow chamber 48 in the torus 26, in which the valve closing part 10 is arranged in a stationary manner. In a fourth step, the fluid flows through the passages 30 in the annular flange 28 of the valve closing part 10 and enters the remaining torus chamber 66. In a final step, the fluid flows through the fluid outlet A in an essentially straight line.

If the valve device is opened, i.e. if the free end of the hollow cylindrical valve part 6 moves away from the end face of the valve closing part 10 arranged stationary in the housing 4, the fluid exits from the valve part 6 and is routed radially deflected 90° outwards along the closing plate 32 of the valve closing part 10 in a throttled manner. It then hits the inside of the sealing insert 50 at a reduced speed and the deflection or reversal of direction of the fluid by 180° described above occurs, owing to the one flow guide device 34 having the outwardly oriented control edge 45 of the valve closing part 10. For the valve in the slightly open position, the corresponding fluid flow is strongly throttled, which increases the stability of the fluid routing. In addition to the first reversal of direction by the control edge 43 of the valve part 6, there is a further reversal of direction in the opposite direction via the further flow guide device 36 having the control edge 45 of the valve closing part in the direction of the fluid outlet A of the valve device. Here, too, there is a further throttling at the beginning of the opening process, reducing the dynamics while opening the valve device. When the valve part 6 is opened further, the throttling via the two flow guide devices 34, 36 as the overall flow guide device of the valve device decreases and the fluid velocity increases. The fluid flows at the fluid inlet E and at the fluid outlet A of the valve device are then oriented in parallel, preventing any flow losses from resulting in turbulent flow patterns within the filter device, which otherwise might result in cavitation, which occurs otherwise in particular at the valve closing part 10. The throttling of the fluid flow during the opening process described above is also present in the opposite direction when the valve device is closed, such that the valve part 6 only comes into contact with the valve closing part 10 in a damped manner, which helps to avoid the dreaded closing impacts. The two flow guide devices 34, 36 also contribute to the valve part 6 remaining in the closed position (see FIG. 1) independent of any pressure fluctuations at the fluid inlet E or at the fluid outlet A, because in particular the further flow guide device 36 having the control edge 45 helps to prevent such pressure fluctuations from affecting the front end of the valve part 6 without a shield. The control edge 43 of the valve part 6 being sunk in the elastomeric material of the closing plate 32 in a sealing manner thereby forming an annular contact also contributes to the stabilization of the closing position of the valve part. Because the control surfaces of the valve part 6 are protected against an unwanted fluid attack, it is no longer necessary to design one energy storage device in the form of the compression spring 8 to be particularly strong or rigid, which might have a negative effect on the overall energy balance of the valve device, because a stronger actuating magnet 16 is then required for the valve part 6 to move the magnet armature 18 against the action of the compression spring 8. This is without parallel in the prior art.

1. A valve device having a valve housing (4), in which a hollow valve part (6) is guided in a longitudinally movable manner, which valve part, controlled by an actuating device (8,14), in at least one open position opens the fluid path through the valve between a fluid inlet (E) and a fluid outlet (A) along a predeterminable flow path for a fluid and in a closed position, in which the valve part (6) is in contact with a valve closing part (10) from which it lifts off in the respective open position, blocks this fluid path, characterized in that there is at least one flow guide device (34) causing an at least partial reversal of direction in the flow path of the fluid emerging from the valve part (6) as soon as the latter assumes an open position.

2. The valve device according to claim 1, characterized in that in the direction of the flow path of the fluid, at least one further flow guide device (36) adjoins the one flow guide device (34) in sequence, which complements the reversal of direction effected by the one flow guide device (34) by an at least partial reversal of direction in the flow path of the fluid such that, preferably after the fluid has passed through the two reversals of direction of the fluid, the rectilinear fluid flow direction predominantly present in the valve part (6) is restored after passing through both flow guide devices (34, 36).

3. The valve device according to claim 1 or 2, characterized in that the one flow guide device (34) is formed from parts of the valve part (6) and of the valve closing part (10) which, in the course of the reversal of direction, to this extent delimit the flow path of the fluid emerging from the valve part (6) in its open position.

4. The valve device according to any one of the preceding claims, characterized in that the further flow guide device (36) is formed from parts of the one flow guide device (34) and from a guiding device (38), which is preferably formed from wall parts of the valve housing (4).

5. The valve device according to any one of the preceding claims, characterized in that the two flow guide devices (34, 36) forming an overall flow guide device are co-planar, which at least one plane extends through the longitudinal axis (L) of the valve part (6) and in which the flow path of the fluid is wave-shaped.

6. The valve device according to any one of the preceding claims, characterized in that the two flow guide devices (34, 36) are at least partially formed from wall parts of the valve part (6), the valve closing part (10) and the guiding device (38), which in a concentric arrangement to each other delimit annular flow chambers (40) between the valve part (6) and the valve closing part (10) and between this closing part (10) and the guiding device (38).

7. The valve device according to any one of the preceding claims, characterized in that the valve closing part (10) is arranged stationarily in the valve housing (4) and has a closing plate (32) of preferably elastomeric material, against which the valve part (6) is brought into sealing contact in its closed position upon the action of an energy storage device (8) as one part of the actuating device (8, 14) for a not energized actuating magnet (16) as a further part of the actuating device (8,14).

8. The valve device according to any one of the preceding claims, characterized in that in the fully open position of the valve part (6), a magnet armature (18) of the actuating magnet (16) has moved until it is in full contact against a pole core (22) of the actuating device (8, 14), leaving open a separating gap (20) and in that in doing so the valve part (6) in its axial direction of travel is disengaged from the valve closing part (10) and the end faces of the valve part (42) and the valve closing part (10) facing each other are axially spaced apart.

9. The valve device according to any one of the preceding claims, characterized in that in the closed position of the valve part (6) its free end face (42) in the manner of a control edge (43) is enclosed by an annular control edge (45) of a different type of valve closing part (10), forming one flow chamber (44).

10. The valve device according to any one of the preceding claims, characterized in that, when the valve part (6) is increasingly opened, its free end face (42) moves away from the closing plate (32) of the valve closing part (10) in the axial direction, enlarging the one flow chamber (44).

11. The valve device according to any one of the preceding claims, characterized in that in the fully open position of the valve part (10), its one free end face (42) is flush with the guiding device (38), which co-delimits the further flow chamber (48).

12. The valve device according to any one of the preceding claims, characterized in that the respective annular control edges (43, 45) are co-delimited by a conically inclined annular surface (62, 64) on the valve part (6) and/or on the valve closing part (10) at their respective free ends, and in that the annular surface (64) of the valve closing part (10) is inclined in the direction of the fluid outlet (A) and that the other annular surface (62) of the valve part (6) is inclined in the direction of the fluid inlet (E).

13. The valve device according to any one of the preceding claims, characterized in that the valve closing part (6) is accommodated in the valve housing (4) between housing parts (24) thereof, preferably in a clamping manner, which co-delimit a kind of torus (26), which is co-formed by the further flow chamber (48), which preferably adjoins the other torus chamber (66) in a continuously widening manner.

14. The valve device according to any one of the preceding claims, characterized in that the valve closing part (10) passes through the torus (26) and has passages (30) arranged on an annular flange (28), both ends of which open into the torus (26), which opens in the direction of the fluid outlet (A) at the outlet end.
